(19) United States
(12) Patent Application Publication
(10) Pub. No.: US 2008/0135165 A1
(43) Pub. Date: Jun. 12, 2008

(54) Method For Forming Container With Reinforcing Member

(75) Inventor: Kenneth R. Potter, Atlanta, IN (US)

Correspondence Address: BARNES & THORNBURG LLP, 600 ONE SUMMIT SQUARE, FORT WAYNE, IN, 46802, US

(73) Assignee: Peerless Machine & Tool Corporation, Marion, IN (US)

(21) Appl. No.: 11/568,107

(22) PCT Filed: Apr. 25, 2005
(86) PCT No.: PCT/US05/14042

§ 371 Date: Aug. 28, 2007

Related U.S. Application Data
(60) Provisional application No. 60/566,219, filed on Apr. 28, 2004.

(51) Int. Cl. B29C 47/08

(52) U.S. Cl. 156/245

(57) ABSTRACT

A method for forming a container (60) with a reinforcing member (48) from paperboard or other suitable materials. The method includes forming a container (60) from a blank (30) through use of a press (20). A reinforcing member (48) is disposed adjacent the container (60) and press (20). The reinforcing member (48) is subsequently bonded to the container (60) through use of the press (20).

### RELATED APPLICATION

The present PCT Patent Application claims priority to U.S. Provisional Patent Application No. 60/566,219, filed Apr. 28, 2004, entitled Method For Forming Container With Reinforcing Member. To the extent not included below, the subject matter disclosed in this application is hereby expressly incorporated into the present application.

### FIELD OF THE INVENTION

The present invention relates to formed containers having a reinforcing member. More specifically, the present invention relates to a method of forming a container from paperboard (or other suitable materials) having a reinforcing member.

### BACKGROUND AND SUMMARY

Containers made of paperboard or other suitable materials for holding various materials and articles have been produced for some time. Design improvements to such containers, however, continue to be made, allowing for stronger containers to be produced. The container strength can determine the amount of weight a container can support. Several design factors can be manipulated to increase container strength, such as the container material and material thickness. Reinforcing members can also be used to increase the strength of a container.

Reinforcing members can be formed of the same materials that form the container. A reinforcing member can fit around the perimeter of a container rim increasing support. The reinforcing member allows a container having a flange to be lifted at the flange without the container collapsing when supporting weight, while the container maintains its shape. Also, reinforcing members may provide a smoother sealing surface. Reinforcing members are known in the art and are currently utilized.

The present invention relates to a method for forming a container having a reinforcing member. In one illustrative embodiment method, a press having female and male dies for forming a container. Then, while the container remains in the press, a reinforcing member is introduced into the press. The reinforcing member and formed container are then pressed and heated together allowing the reinforcing member and container to bond.

Another illustrative method includes a male and a female die and a draw ring for forming a container. The female die includes a vacuum to hold the container when the male and female dies separate. A reinforcing member is then centered on the male die with the male and female dies subsequently closing together while applying heat, thereby causing the reinforcing member and container to bond together.

Another illustrative method allows the reinforcing member to be in the form of a ring. A reinforcing ring is taken from a reservoir of reinforcing rings using a vacuum to grip the reinforcing ring. The vacuum then places the reinforcing ring on a guide to deliver the reinforcing ring to the male and female forming dies. The reinforcing ring is then introduced between the dies allowing it to be bonded with a previously formed container through the application of both pressure and heat.

The aforementioned illustrative methods provide various advantages to current methods of forming containers with reinforcing members. One advantage is allowing the heated, container-forming dies to be utilized in bonding the reinforcing member to the container. This allows a combination of heat and pressure to be used to soften the coating on a formed container flange and reinforcing member, while the two are held under pressure by the dies. This softening effect allows a bond to be formed between the reinforcing member and container. Additives may be used to enhance the bonding effect of the applied heat and pressure. Adhesives may also be used to supplement the bonding. The use of the male and female container-forming dies removes the need for other bond-forming machinery.

Another advantage of the illustrative methods is the positioning of the reinforcing member and container. The female die retains the container while the reinforcing member is centered using the male die, thus allowing the container and reinforcing member to be easily aligned before being bonded together. Another advantage of the illustrative methods is the reduction in time to form the bond between the reinforcing member and the container. The heated male and female dies allow the container to remain above ambient temperature during the entire forming process. When the reinforcing member is introduced into the dies, the container is already heated. This allows the pressure-application time to be reduced, since the container need not be reheated to form the bond with the reinforcing member.

Additional features and advantages of the present invention will become apparent to those skilled in the art upon consideration of the following detailed descriptions exemplifying the best mode of carrying out the method as presently perceived.

### BRIEF DESCRIPTION OF THE DRAWINGS

The present invention will be described hereafter with reference to the attached drawings which are given as non-limiting examples only, in which:

FIG. 1A is a cross-sectional view of an illustrative embodiment of a container without a reinforcing ring.

FIG. 1B is a cross-sectional view of an illustrative embodiment of a container having a reinforcing ring.

FIG. 1C is a detailed cross-sectional view of the container of FIG. 1B.

FIG. 2 shows a schematic representation of machinery illustratively engaged in loading a blank into a press.

FIG. 3 shows a schematic representation of the machinery of FIG. 2 illustratively engaged in preparing to form a container.

FIG. 4 shows a schematic representation of the machinery of FIG. 2 illustratively engaged in forming a container.

FIG. 5 shows a schematic representation of the machinery of FIG. 2 illustratively engaged in loading a reinforcing ring into a press.

FIG. 6 shows a schematic representation of the machinery of FIG. 2 illustratively engaged in positioning a reinforcing ring into a press.

FIG. 7 shows a schematic representation of the machinery of FIG. 2 illustratively engaged in bonding a formed container to a reinforcing ring.

Corresponding reference characters indicate corresponding parts throughout the several views. The exemplification set out herein illustrates embodiments of the method for forming a container with a reinforcing ring, and such exemplification is not to be construed as limiting the scope of the invention in any manner.

### DETAILED DESCRIPTION OF THE DRAWINGS

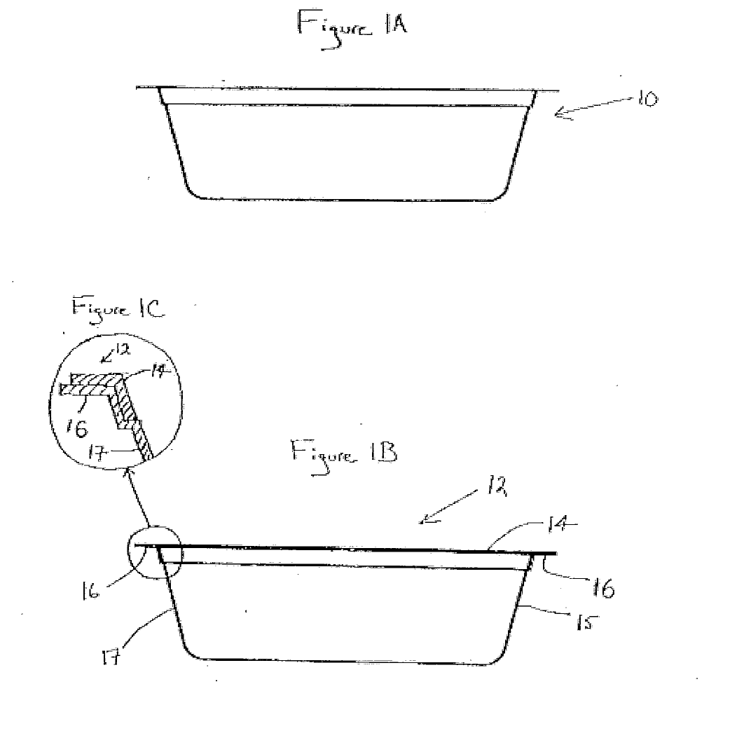

FIG. 1A shows a cross-sectional view of an illustrative embodiment of a container 10 without a reinforcing member. FIG. 1B shows a cross-sectional view of an illustrative embodiment of a container 12 having a reinforcing member in the form of reinforcing ring 14. Reinforcing ring 14 is shown to cover area on flange 16 and sides 15, 17 of container 12. However, it is appreciated that reinforcing ring 14 may cover areas greater or lesser than that illustrated.

FIG. 1C shows a detailed cross-sectional view of reinforcing ring 14 and container 12 fitting together. This detailed figure specifically shows how reinforcing ring 14 is positioned onto flange 16 and side 17 of container 12. The thicknesses shown of container 12 and reinforcing ring 14 are exaggerated and not to scale.

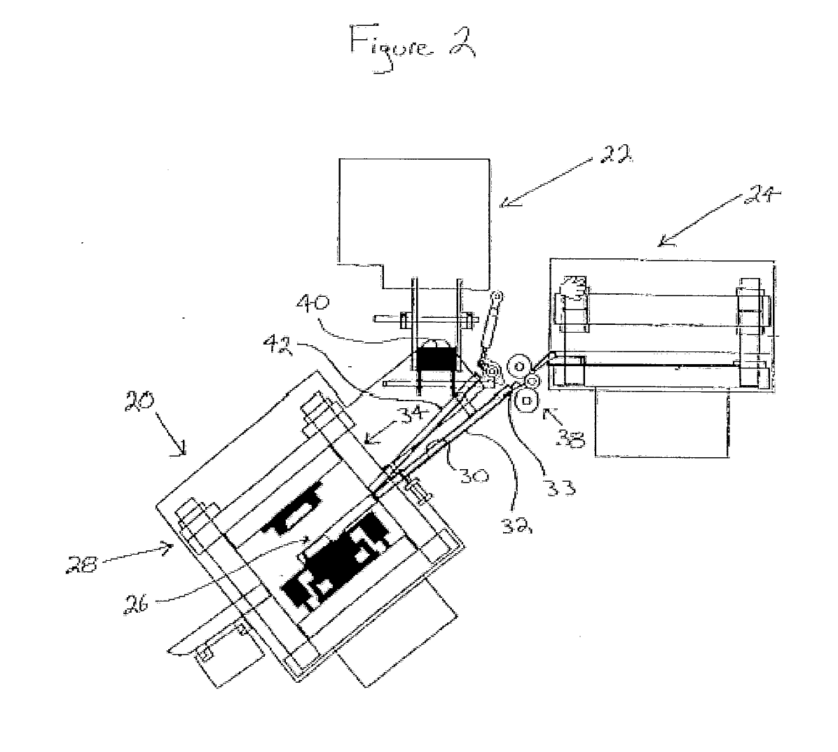

FIG. 2 shows a schematic representation of the machinery illustratively engaged in loading a blank into a press. FIG. 2 illustratively shows the machinery to include press 20, ring dispenser 22, and blank cutting machine 24. The step shown in FIG. 2 shows press 20 as having a formed container with a reinforcing ring 26 positioned therein. Container 26 is prepared to exit press 20 through side 28. As container 26 exits press 20, blank 30 enters press 20 through side 34 on blank guide 32. Blank 30 is ejected from blank cutting machine 24 then moves through roller system 38 onto blank guide 32. During the step illustratively shown in FIG. 2, ring dispenser 22 is prepared to remove a reinforcing ring from ring reservoir 40 and place it on ring guide 42.

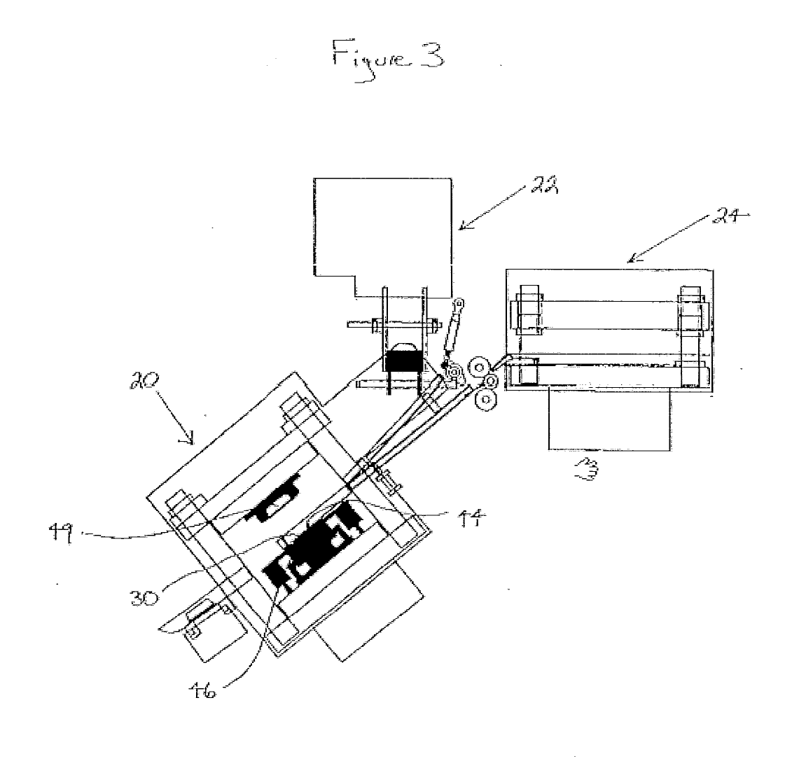

FIG. 3 shows a schematic representation of the machinery illustratively engaged in preparing to form a container. Draw ring 46 is urged upward a fixed distance with controlled-pressure air cylinders surrounding male die 44. With female die 49 and male die 44 separated, blank 30 is positioned between them. Blank 30 is supported by male die 44 and draw ring 46, as illustratively shown in FIG. 3. Female die 49 and male die 44 are heated in preparation of forming a container. Female die 49 and male die 44 are formed to match the finished-container geometry to form three-dimensional containers from a paperboard blank, such as blank 30, for example. As female die 49 closes to contact male die 44, blank 30 is drawn across draw ring 46 under tension and urged into female die 49. The tension allows a container to be formed without unwanted folds.

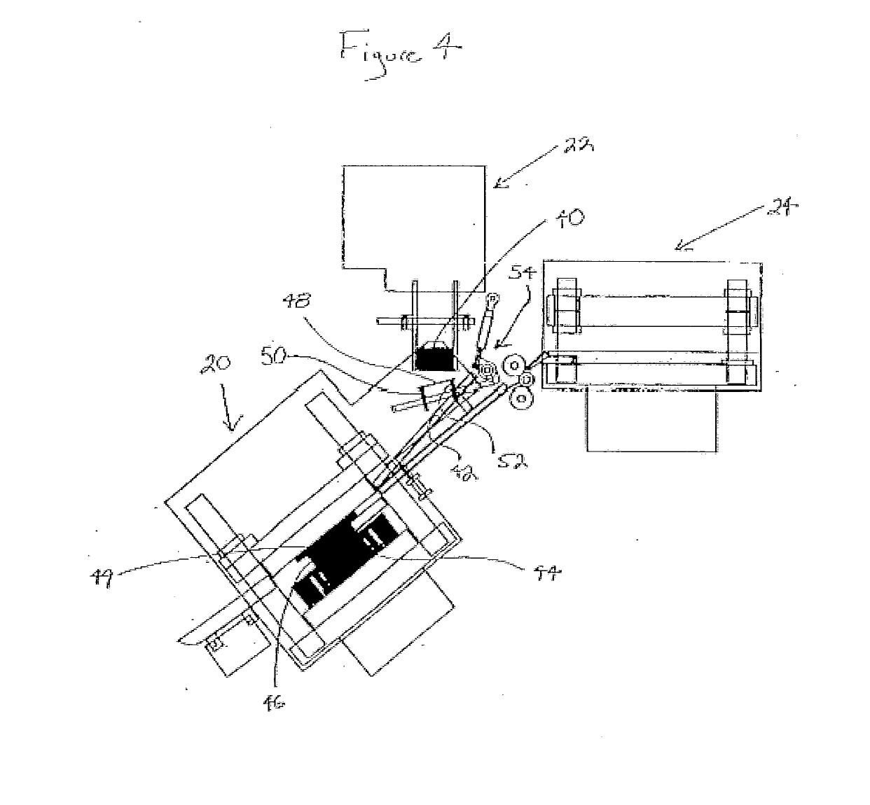

FIG. 4 shows a schematic representation of the machinery illustratively engaged in forming a container. With female die 49 and male die 44 being heated, both pressure and heat are applied to blank 30 during the forming process. As a container is being formed from blank 30, reinforcing ring 48 is removed from ring reservoir 40. Reinforcing ring 48 is removed from the bottom of ring reservoir 40 with vacuum cups 50, 52, which are attached to ring removal system 54. Once ring removal system 54 is appropriately positioned, vacuum cups 50, 52 are deactivated, thereby releasing reinforcing ring 48 onto ring guide 42. The timing of the release is synchronized with the activity of press 20.

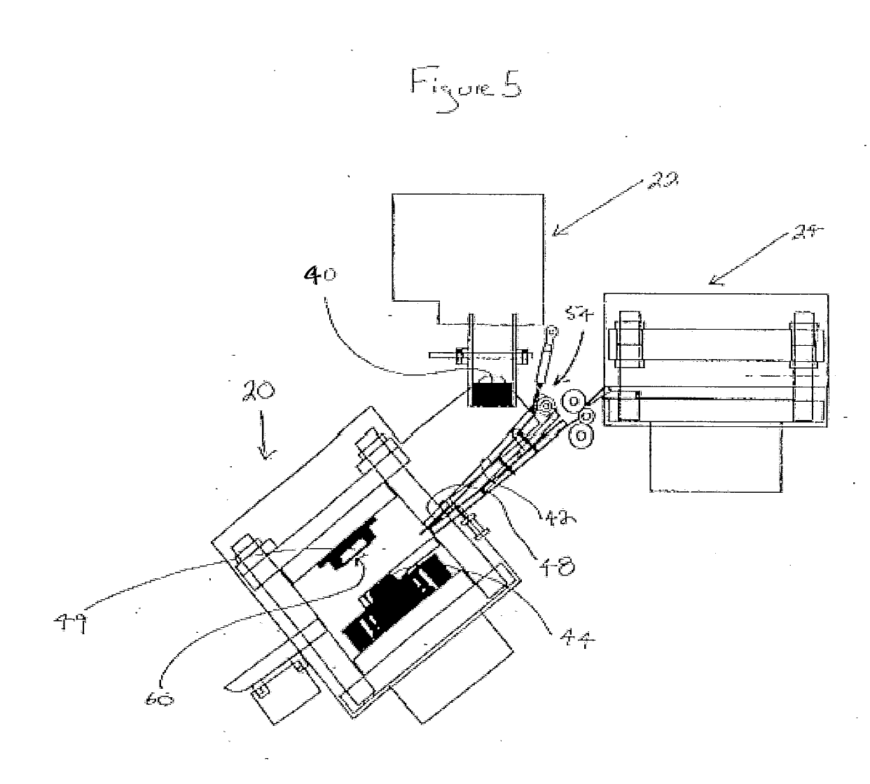

FIG. 5 shows a schematic representation of the machinery of FIG. 2 illustratively engaged in loading reinforcing ring 48 into a press 20. During this step, female die 49 moves away from male die 44 and the pressure cylinders used to urge draw ring 46 are exhausted. Blank 30 has been formed into container 60. Female die 49 includes a vacuum that retains container 60 as female die 49 moves away. Female die 49 and male die 44 remains heated during this step.

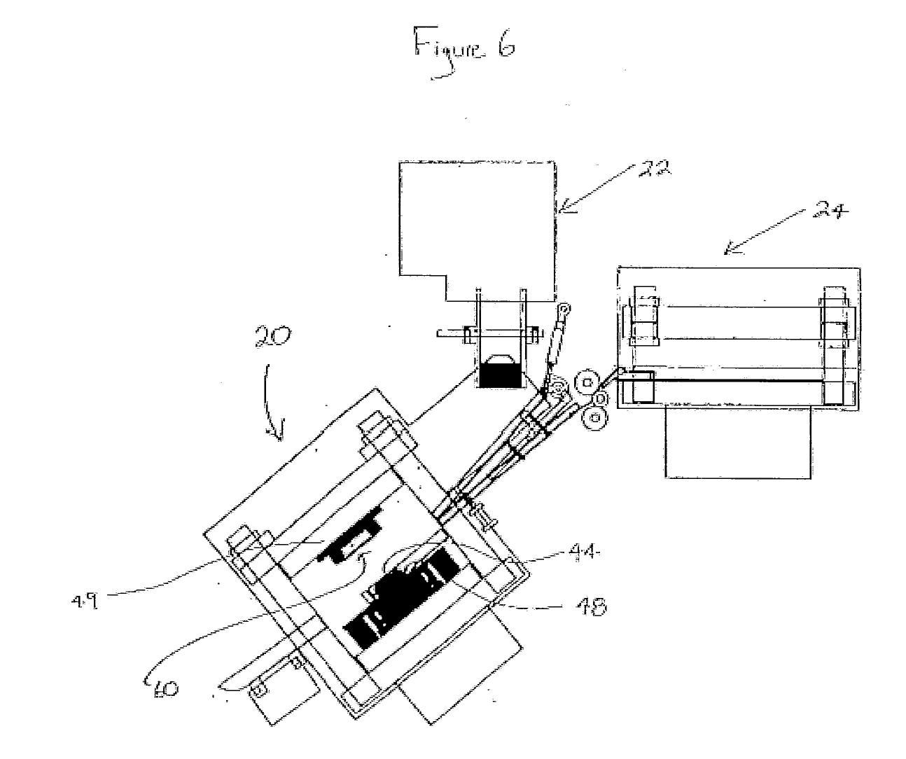

FIG. 6 shows a schematic representation of the machinery of FIG. 2 illustratively engaged in positioning reinforcing ring 48 into press 20. During this step, ring guide 42 has directed reinforcing ring 48 onto male die 44. The respective shapes of male die 44 and reinforcing ring 48 allow reinforcing ring 48 to centralize about male die 44. Once reinforcing ring 48 is in place, female die 49 may be actuated to press container 60 and reinforcing ring 48 together, thereby forming a bond.

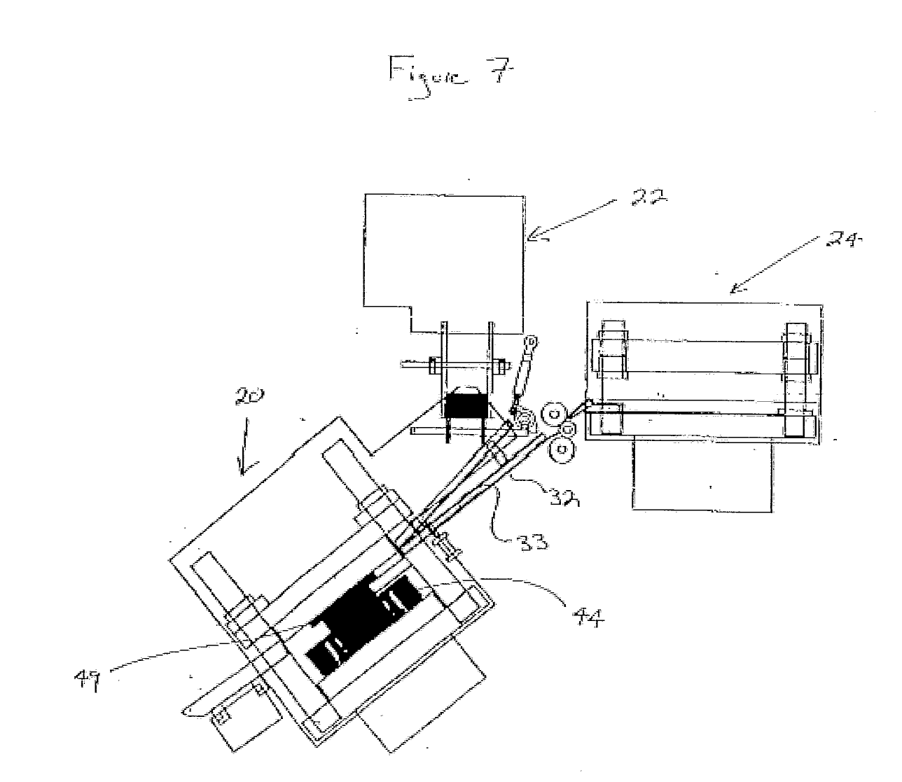

FIG. 7 shows a schematic representation of the machinery of FIG. 2 illustratively engaged in bonding container 60 to reinforcing ring 48. During this step, female die 49 and male die 44 are pressing container 60 and reinforcing ring 48 together. The vacuum pressure being applied by female die 49 is deactivated. The pressure cylinders of draw ring 46 are once again activated, causing draw ring 46 to apply pressure to container 60 and reinforcing ring 48. During the entire forming process, female die 49 and male die 44 remain heated. This allows the bonding process to take a shorter amount of time than a process allowing a container, such as container 60, to cool down. Allowing container 60 to cool down requires that container 60 be reheated to bond with reinforcing ring 48. Maintaining the heat is an efficient use of the heating characteristics of male die 44 and female die 49.

After container 60 and reinforcing member 48 are bonded together, female die 49 moves away from male die 44. Draw ring 46 simultaneously extends toward female die 49. Draw ring 46 extends as far out as its travel limit allows. Once female die 49 moves an appropriate amount, container 60 with bonded reinforcing ring 48 is ejected from press 20. FIG. 7 also shows blank 33 on blank guide 32 with blank 33 ready to be positioned onto male die 44 in preparation of repeating the forming process.

Corresponding reference characters indicate corresponding parts throughout the several views. The exemplification set out herein illustrates an embodiment of the invention, in one form, and such exemplification is not to be construed as limiting the scope of the invention in any manner.

Although the present invention has been described with reference to particular means, materials and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A method for forming a container having a reinforcing member, the steps comprising:
a) loading a blank into a press;
b) preparing the press to form a container;
c) forming the blank into a container with the press;
d) loading a reinforcing member into the press; and
e) bonding the container and the reinforcing member to one another.

2. The method of claim 1, wherein the press comprises male and female die members, each having pressing surfaces.

3. The method of claim 2, wherein the step of loading a blank comprises:
1) releasing a blank onto a blank guide;
2) guiding the blank with the blank guide into the press; and
3) positioning the blank between the male and female die members.

4. The method of claim 2, wherein the step of preparing the press comprises:
1) heating the male and female die members;
2) activating a draw ring to tighten the blank across the male die member.

5. The method of claim 2, wherein the step of forming the container comprises:
1) engaging the male and female die members with one another;
2) pressing the blank through the engagement of the male and female die members;
3) forming the blank into a container; and
4) shaping the container to that of the pressing surfaces of the male and female die members.

6. The method of claim 5, wherein the step of loading the reinforcing member comprises:
1) disengaging the male and female die members;
2) retaining the container within the female die member;
3) removing the reinforcing member from a reservoir;
4) placing the reinforcing member onto a member guide;
5) guiding the reinforcing member into the press with the member guide; and
6) positioning the reinforcing member onto the male die member.

7. The method of claim 6, wherein the step of bonding the container and reinforcing member to one another comprises:
1) re-engaging the male and female die members;
2) pressing the container and reinforcing member together; and
3) bonding the reinforcing member to the container through the application of heat and pressure.

8. The method of claim 7, wherein the step of bonding the container and reinforcing member to one another further comprises supplying an additive to enhance the bonding effect of the applied heat and pressure.

9. The method of claim 7, wherein the step of bonding the container and reinforcing ring to one another further comprises supplying an adhesive to strengthen the bond between the container and reinforcing member.

10. The method of claim 1, wherein the blank comprises paperboard.

11. The method of claim 6, wherein the reinforcing member comprises a reinforcing ring.

12. The method of claim 11, wherein the reinforcing ring is positioned on the male die member such that the male die member is disposed therethrough, thereby centering the reinforcing ring about the male die member.

13. A container having a reinforcing member, formed by a method comprising the steps of:
a) loading a blank into a press;
b) preparing the press to form a container;
c) forming the blank into a container with the press;
d) loading a reinforcing member into the press; and
e) bonding the container and the reinforcing member to one another.

14. The container of claim 13, wherein the press comprises male and female die members, each having pressing surfaces.

15. The container of claim 14, wherein the step of loading a blank comprises:
1) releasing a blank onto a blank guide;
2) guiding the blank with the blank guide into the press; and
3) positioning the blank between the male and female die members.

16. The container of claim 14, wherein the step of preparing the press comprises:
1) heating the male and female die members;
2) activating a draw ring to tension the blank across the male die member.

17. The container of claim 14, wherein the step of forming the container comprises:
1) engaging the male and female die members with one another;
2) pressing the blank through the engagement of the male and female die members;
3) forming the blank into a container; and
4) shaping the container to that of the pressing surfaces of the male and female die members.

18. The container of claim 17, wherein the step of loading the reinforcing member comprises:
1) disengaging the male and female die members;
2) retaining the container within the female die member;
3) removing the reinforcing member from a reservoir;
4) placing the reinforcing member onto a member guide;
5) guiding the reinforcing member into the press with the member guide; and
6) positioning the reinforcing member onto the male die member.

19. The container of claim 17, wherein the step of bonding the container and reinforcing member to one another comprises:
1) re-engaging the male and female die members;
2) pressing the container and reinforcing member together; and
3) bonding the reinforcing member to the container through the application of heat and pressure.

20. The container of claim 13, wherein the blank comprises paperboard.

21. The container of claim 18, wherein the reinforcing member comprises a reinforcing ring.

22. The container of claim 21, wherein the reinforcing ring is positioned on the male die member such that the male die member is disposed therethrough, thereby centering the reinforcing ring about the male die member.
